(19) United States
(12) Patent Application Publication
(10) Pub. No.: US 2006/0094629 A1
(43) Pub. Date: May 4, 2006

(54) Cleaning composition with time-release cleaning

(76) Inventor: Isaac B. Horton III, Raleigh, NC (US)

Correspondence Address: Isaac B. HORTON, III, 8824 Stage Ford Road, Raleigh, NC, 27615, US

(21) Appl. No.: 11/301,966

(22) Filed: Dec. 13, 2005

Related U.S. Application Data
(63) Continuation-in-part of application No. 10/868,464, filed on Jun. 15, 2004.

(51) Int. Cl. C11D 17/08

(52) U.S. Cl. 510/421; 510/499

(57) ABSTRACT

A cleaning composition comprising a water-soluble organic solvent, at least one surfactant which comprises an amide, at least one additional surfactant, a chelating agent, an encapsulated disinfecting agent, and distilled water. The preferred embodiment of the cleaning composition consists of all-natural components.

### CROSS-REFERENCE TO RELATED APPLICATIONS

This nonprovisional utility patent application is copending with nonprovisional application Ser. No. 10/868,649 filed on Jun. 15, 2004, and nonprovisional application Ser. No. 10/868,541 filed on Jun. 15, 2004, and nonprovisional application Ser. No. 10/868,464 filed on Jun. 15, 2004; it is a continuation in part of these applications.

### BACKGROUND OF THE INVENTION

(1) Field of the Invention

The present invention relates generally to a cleaning composition and, more particularly, to an all-purpose cleaning composition for use as a spray cleaner in cleaning textiles, glass, automobiles, and hard surfaces wherein the cleaner comprises an encapsulated disinfectant which, after deposition on a surface, is slowly released over an extended period of time.

(2) Description of the Prior Art

There are a large number of cleaning products currently on the market. Typically, cleaning compositions, detergents, and the like contain a combination of many components including but not limited to anionic surfactants, cationic surfactants, nonionic surfactants, builders, suds-stabilizers, buffers, disinfecting agents, wetting agents, and chelating agents. Often these cleaning compositions employ components that may have adverse effects on the environment such as phosphorous compounds, peroxygen compounds, chlorine bleach compounds, and fluorinated compounds.

Prior art related to this invention is as follows:

U.S. Pat. No. 6,720,297 issued to Jenevein on Apr. 13, 2004 for a cleaning composition teaches a cleaning composition for treating and removing stains from a non-porous surface has one or more salts, such as quaternary ammonium salts, sulfates and chlorides, a chelator and a dispersant, dissolved in an aqueous solution of alcohol. The preferred salts are myristyltrimethylammonium bromide and benzethonium chloride, the chelator is tetrasodium salt ethylenediamine of tetraacetic acid, and the dispersant is polyvinyl alcohol. The cleaning composition is incorporated into a product, which has a non-woven polyester carrier impregnated with the cleaning composition.

U.S. Pat. No. 5,759,980 issued to Russo, et al. on Jun. 2, 1998 for a car wash teaches a novel car wash composition substantially eliminates water-spotting. This novel car wash composition is comprised of: a surfactant package which is comprised of a first surfactant selected from the group consisting essentially of an anionic surfactant, a nonionic surfactant and mixtures thereof, and a second surfactant selected from the group consisting essentially of fluorosurfactant, a silicone surfactant, and mixtures thereof; and a substantive polymer that renders the surface to be cleaned more hydrophilic.

U.S. Pat. No. 6,732,747 issued to Wise on May 11, 2004 for a composition and method for cleaning and disinfecting a garbage disposal teaches an improved composition and method for cleaning and disinfecting a garbage disposal that does not require aerosol propellants or carbon dioxide gas generating reaction systems. The composition comprises a suds stabilizing surfactant and a disinfecting agent, plus other optional ingredients such as additional detergent surfactant and scouring agents. The required disinfecting agent is selected from the group consisting of quaternary ammonium compounds, halogenated compounds, phenolics, alcohols, aldehydes, oxidizing agents and mixtures thereof.

United States Patent Application Pub. No. 20040043041 to Baker, et al. on Mar. 4, 2004 for antimicrobial compositions and methods of use teaches compositions and methods for decreasing the infectivity, morbidity, and rate of mortality associated with a variety of pathogenic organisms and viruses. The reference invention also relates to methods and compositions for decontaminating areas colonized or otherwise infected by pathogenic organisms and viruses. Moreover, the reference invention relates to methods and compositions for decreasing the infectivity of pathogenic organisms in foodstuffs. In particular, decreased pathogenic organism infectivity, morbidity, and mortality are accomplished by contacting the pathogenic organism with an oil-in-water nanoemulsion comprising an oil, an organic solvent, and a surfactant dispersed in an aqueous phase. In some preferred embodiments, the solvent comprises an organic phosphate solvent. In still other embodiments, the organic phosphate-based solvent comprises dialkyl phosphates or trialkyl phosphates (e.g., tributyl phosphate).

While these compositions can lead to a useful cleaning agent, a simpler composition that retains superior cleaning activity while reducing the number of components could simplify the manufacturing process potentially reducing production costs without sacrificing product quality. Further, many of these cleaning compositions employ components that may have adverse effects on the environment.

Controlled release of active agents is a concept well known in pharmaceuticals and in drug delivery applications in particular. There are some examples of controlled release of active agents in cleaning compositions, but most of these examples relate to controlled release during a cleaning process such as during various cycles of a clothes washer or dishwasher, or controlled release of cleaning or fragrance from a pre-moistened wipe while the wipe is being used. There are far fewer examples of controlled release of active agents from a cleaned surface subsequent to the cleaning process.

The following prior art is related to controlled release of active agents:

U.S. Pat. No. 6,825,161 issued to Shefer on Nov. 30, 2004 for Multi component controlled delivery system for soap bars teaches an improved controlled delivery system that can be incorporated in soap bars to enhance deposition of active ingredients and sensory markers onto skin. The carrier system also provides controlled release or prolonged release of these actives from the skin over an extended period of time.

U.S. Pat. No. 6,740,631 issued to Shefer on May 25, 2004 for multi component controlled delivery system for fabric care products teaches an improved controlled delivery system that can be incorporated in dry granular, or powder, fabric care products, such as laundry detergents, tumble dryer sheets, rinse added products, and other fabric care products, to enhance fragrance performance. The fragrance carrier system also provides controlled release or prolonged fragrance release from the dry laundered fabric over an extended period of time, or yields a high impact fragrance “burst” upon ironing the fabric.

U.S. Pat. No. 6,362,159 issued to Aquadisch, et al. on Mar. 26, 2002 for domestic care product teaches a domestic care product comprising a fragrance particle wherein the particle comprises a fragrance composition and at least one silicone polymer having a melting point of at least 10.degree. C., provided that at least 20% of the silicone atoms in the silicone polymer have a substituent of 16 carbon atoms or more. The fragrance may be employed in relatively small proportions and yet deliver fragrance to a domestic care product over a prolonged period of time by use these silicone polymers.

U.S. Pat. No. 5,154,842 issued to Walley, et al. on Oct. 13, 1992 and U.S. Pat. No. 5,066,419 issued to Walley, et al. on Nov. 19, 1991 both for coated perfume particles both teach perfume particles comprising perfume dispersed within certain water-insoluble nonpolymeric carrier materials and encapsulated in a protective shell by coating with a friable coating material. The coated particles allow for preservation and protection of perfumes which are susceptible to degradation or loss in storage and in cleaning compositions. In use, the surface coating fractures and the underlying carrier/perfume particles efficiently deliver a large variety of perfume types to fabrics or other surfaces.

U.S. Pat. No. 4,152,272 teaches incorporating perfume into wax particles to protect the perfume during storage and through the laundry process. The perfume/wax particles are incorporated into an aqueous fabric conditioner composition. The perfume then diffuses from the particles onto the fabric in the heat-elevated conditions of the dryer.

US Pat App 20030158076 filed on Feb. 8, 2002 by Rodriguez for Amide polymers for use in surface protecting formulations teaches surface protection composition comprising a polymer having at least one amide monomer unit, where the amide monomers are free of amine linkages. The polymer also provides a vehicle for the controlled release of actives. This application, however, seems to be limited to agricultural applications. The polymer composition of the invention may also be used in agricultural applications to coat actives like fertilizers and seeds. The coated actives can be introduced into the soil and the actives released over a period of time. The time period of release can be controlled by the pH range of the soil, the ratio of hydrophobe to hydrophilic monomer in the polymer, the amount of neutralization and the ratio of volatile to non-volatile neutralization agent.

WO 03/082356 A2 filed by Dow Corning Corporation on Mar. 27, 2003 for emulsions teaches an emulsion for controlled fragrance release comprises a disperse phase which is a blend of a fragrance composition and a waxy hydrophobic material having a melting point in the range 10-200 degrees C. dispersed in a continuous phase comprising an aqueous solution of concentration at least 0.1 molar of a salt capable of ionic disassociation in water.

U.S. Pat. No. 6,841,090 issued to Allighieri, et al. on Jan. 11, 2005 for disinfecting composition and process for disinfecting surfaces teaches liquid disinfecting compositions comprising an effective amount of a disinfecting material and a poly (alkylene glycol) ether having the following formula: R.sub.1-O—(CH.sub.2-CHR.sub.2 O).sub.n-R.sub.3, wherein R.sub.1 and R.sub.2 are each independently hydrogen or a substituted or unsubstituted, saturated or unsaturated, linear or branched hydrocarbon chain having from 1 to 30 carbon atoms or a hydroxy bearing linear or branched hydrocarbon chain having from 1 to 30 carbon atoms. R.sub.3 is a substituted or unsubstituted, saturated, or unsaturated, linear or branched hydrocarbon chain having from 1 to 30 carbon atoms or a hydroxy bearing linear or branched hydrocarbon chain having from 1 to 30 carbon atoms, and n is greater than 2. Processes of disinfecting and hard-surface employ such a composition.

While the prior art does disclose controlled release of active agents, none of the references is specifically related to a cleaning composition for a wide variety of surfaces which imparts a lasting disinfectant to those surfaces and which has an environmentally friendly composition. Thus, there remains a need for a superior cleaning composition which leaves a cleaned surface with a lasting disinfectant wherein the composition has a simple composition that is environmentally friendly, easily formulated, and cost effective.

### SUMMARY OF THE INVENTION

Timed release of fragrance from a cleaning product, from the skin after washing, or from textiles after laundering has been reported (U.S. Pat. No. 6,362,159; WO 03/082356 incorporated herein by reference in their entirety). U.S. Pat. No. 6,841,090, incorporated herein by reference in its entirety, sets out a specific polymeric additive which prolongs disinfecting properties of a disinfecting composition comprising a peroxygen bleach antimicrobial agent. The prior art of which applicant is aware does not set forth an environmentally friendly cleaning composition for use in cleaning a variety of materials which also imparts a lasting disinfectant to the cleaned surface. The present invention is directed to a cleaning composition for use in cleaning a range of materials including but not limited to textiles, glass, automobiles, and hard surfaces and which imparts a lasting disinfectant to the cleaned surface. Thus, the present invention provides a cleaning composition comprising a water-soluble organic solvent, at least one surfactant which comprises at least one amide, at least one additional surfactant, a chelating agent, an encapsulated disinfecting agent, and distilled water; thereby providing a superior cleaning composition which leaves a lasting disinfectant on a cleaned surface and which has a simple composition that is easily formulated and cost effective.

### DETAILED DESCRIPTION OF THE PREFERRED EMBODIMENTS

The present invention provides an all-purpose cleaning composition with superior cleaning ability for a range of materials including but not limited to textiles, glass, automobiles, and hard surfaces. The cleaning composition includes an encapsulated disinfecting agent and may further include at least one preservative. The cleaning composition may further include at least one enhancing agent.

Cleaning Composition

The cleaning composition contains the following components:

(a) at least one water-soluble organic solvent present in a solubilizing effective amount;

(b) at least one amide surfactant which may be the product of the saponification of at least one fatty acid by an amino alcohol in a water-soluble organic solvent, wherein the amide surfactant is present in a cleaning-effective amount;

(c) at least one additional surfactant present in a cleaning-effective amount;

(d) a chelating agent capable of chelating multivalent metal ions, wherein the chelating agent is present in an amount effective to prevent phase reversal of the oil-in-water emulsifier;

(e) a disinfecting agent encapsulation element, wherein the disinfecting agent is released from the cleaned surface over an extended period of time after the cleaning process has been completed; and

(f) the remainder, distilled water.

Additional adjuncts in small amounts can be included to provide desirable attributes of such adjuncts. Additional adjuncts can include but are not limited to dyes, fragrance, or the like.

In the application, effective amounts are generally those amounts listed as levels of ingredients in the descriptions which follow hereto. Unless otherwise stated, amounts listed in percentages are in weight percents (%'s) of the composition.

Solvent

The solvent should be a water-soluble organic solvent. Further, the solvent is preferably a water-soluble organic alcohol. The most preferred water-soluble organic solvent is tetrahydrofurfuryl alcohol (THF-A). THF-A is an organic solvent that is completely miscible with water. THF-A has an extensive history of use as a highly versatile, high purity solvent. Due to its relatively benign nature and the fact that it is not oil-based, THF-A is generally regarded as a “green” solvent in industrial applications. THF-A readily biodegrades in soil, sludge, and water. The atmospheric half life is 13 hours. Unused THF-A is not classified as a hazardous waste under the Resource Conservation and Recovery Act.

Surfactants

The first surfactant is at least one amide. The preferred amide is at least one naturally occurring amide. The most preferred amide is a member of the group of amides comprising compounds with the structure CH₃(CH₂)ₓCONH(CH₂)₂OH, wherein the value of x is preferably any whole number between and including 14 and 22; CH₃(CH₂)ₓCH═CH(CH₂)_{y}CONH(CH₂)₂OH, wherein the value of x+y is preferably any whole number between and including 12 and 16; CH₃(CH₂)ₓCH═CH(CH₂)_{y}CH═CH(CH₂)_{z}CONH(CH₂)₂OH, wherein the value of x+y is preferably any whole number between and including 10 and 14; and mixtures thereof.

In another embodiment, the first surfactant may be the product of the saponification of at least one fatty acid by an amino alcohol in a water-soluble organic solvent. The preferred at least one fatty acid is chosen from the group comprising saturated fatty acids of the general formula CₓH₂ₓO₂, wherein the value of x is preferably any whole number between and including 16 and 24; monounsaturated or polyunsaturated fatty acids of the general formula CₓH_{(2x-y)}O₂,wherein the value of x is preferably any whole number between and including 16 and 20 and the value of y is preferably either 2 or 4; and mixtures thereof. A more preferred fatty acid is one chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and mixtures thereof. The most preferred fatty acid is tall oil also known as pine oil. Tall oil is commercially available as MeadWestvaco L-5, marketed by MeadWestvaco, which comprises at least 95% tall oil fatty acid and less than 5% rosin acids. Any suitable fatty acid may contain rosin acids present in small amounts not to exceed about 5% by weight of the total weight of the fatty acid. The preferred amino alcohol is an ethanolamine. The most preferred amino alcohol is monoethanolamine.

The at least one additional surfactant is preferably at least one polyethylene oxide condensate of an alkyl phenol. Suitable additional surfactants are octylphenol ethoxylates that have the chemical formula C₈H₁₇(C₆H₄)O(CH₂CH₂O)ₓH, wherein the average value of x for any mixture of these compounds is preferably any number between and including 3 and 11. Optimally two surfactant mixtures are used, wherein the average value of x for the first additional surfactant mixture is preferably 4.5, and wherein the average value of x for the second additional surfactant mixture is preferably 9.5. These preferred additional surfactant mixtures are commercially marketed under the names Triton X-45 and Triton X-100 by The Dow Chemical Company.

Chelating Agent

The chelating agent is required to chelate multivalent metal ions and thus prevent phase reversal of the oil-in-water emulsifier. The preferred chelating agent is an aminocarboxylic acid salt. The most preferred chelating agent is tetrasodium ethylenediaminetetraacetic acid (Na₄EDTA). This compound is commercially marketed as an aqueous solution of about 38% by weight Na₄EDTA under the name Versene by The Dow Chemical Company.

Disinfecting Agent Encapsulation Element

The disinfecting agent encapsulation element of the present invention comprises a disinfecting agent and any material which comprises that disinfecting agent such that the disinfecting agent is slowly released from that material over a period of time. Encapsulation as used herein refers to any means of containing the disinfecting agent and the encapsulation may be in the form of a pellet, granule, capsule containing smaller particles or microcapsules, or the like. The encapsulation may be in the form of a surface coating which slows evaporation of the disinfecting agent. The term encapsulate is not meant to limit the means by which the disinfecting agent is contained within the cleaning composition.

In addition to the disinfecting agent, the disinfecting agent encapsulation element may comprise a polymer such as a polysiloxane; a natural or synthetic organic wax or gum; a long chain fatty acid or waxy ester thereof, for example a monoester such as octadecyl hexadecanoate, a diester such as ethylene glycol distearate, or a tetraester such as pentaeryhthritol tetrastearate; a long chain fatty alcohol; a long chain fatty amine; a long chain fatty amide; an ethoxylated fatty acid or fatty alcohol; a long chain alkyl phenol or polyethylene wax; a polyalkylene or derivative thereof; or combinations of any of the aforementioned materials. In general, the long chain of the fatty acid, alcohol, amine or amide is an alkyl group of at least 12 and preferably at least 16 carbon atoms. The disinfecting agent encapsulation element may be present dispersed as an emulsion in the cleaning composition.

The disinfecting agent may be released by slow diffusion through the encapsulating material, by diffusion though pores in the encapsulating material created by wear or abrasions on the encapsulating material, or by reaction of the encapsulating material such as in response to a stimulus such as light or heat.

Certain additives may be included to modify the rate of release of the disinfecting agent. These additives may increase or decrease the rate of release of the disinfecting agent when the encapsulating material is subjected to particular physical conditions such as heating, compression, or the like.

The disinfecting agent encapsulation element may further include certain additional components which serve as support materials or binders. Supporting material or carrier material is preferably selected from the group consisting of sodium tripolyphosphate, sodium silicate, sodium carbonate, sodium bicarbonate, sodium sulphate, sodium sulphite, sodium chloride, sodium citrate, sodium acetate, sodium perborate, sodium percarbonate, titanium dioxide, zeolite, layered silicate, alumina silicates, natural clays, calcium carbonate, starch and derivatives thereof, cellulose and derivatives thereof, polycarboxylate homo- and co-polymers, talc, silicas, and mixtures thereof. Carrier material may comprise 0-95%, or preferably 5-80% or more preferably, 10-70% by weight of the disinfecting agent encapsulation element composition.

If carrier material is used it is preferably used with a binder. Preferably, binders are selected from the group consisting of polyethylene glycols, polypropylene glycols, sugars, starch and derivatives thereof, cellulose and derivatives thereof, polycarboxylate homo- and co-polymers, polyvinyl pyrrolidone, natural gums, carboxymethyl cellulose, polyvinyl alcohol and mixtures thereof. Binders are preferably present in an amount of 0-20%, more preferably 1-10% by weight of the disinfecting agent encapsulation element composition.

Other additives such as viscosity adjusting components, fillers, colorants, and the like may optionally be incorporated into the disinfecting agent encapsulation element of the present invention.

Disinfecting Agent

The disinfecting agent encapsulation element preferably comprises a disinfecting agent in an amount of from about 1 to about 60% by weight of the disinfecting agent encapsulation element. Preferred disinfecting agents for use in the present invention include antimicrobial agents derived from natural products, plant extracts, essential oils, or combinations thereof. By agents derived from natural products, plant extracts, or essential oils it is meant herein any ingredient of natural products, plant extracts, or essential oils that exhibits antimicrobial activity. Such antimicrobial essential oils include, but are not limited to, those obtained from thyme, lemongrass, citrus, lemons, orange, anise, clove, aniseed, pine, cinnamon, geranium, roses, mint, lavender, citronella, eucalyptus, peppermint, camphor, ajowan, sandalwood, rosmarin, vervain, fleagrass, lemongrass, ratanhiae, cedar and mixtures thereof. Preferred antimicrobial essential oils to be used herein are thyme oil, clove oil, cinnamon oil, geranium oil, eucalyptus oil, peppermint oil, citronella oil, ajowan oil, mint oil or mixtures thereof.

Actives of essential oils to be used herein include, but are not limited to, thymol (present for example in thyme, ajowan), eugenol (present for example in cinnamon and clove), menthol (present for example in mint), geraniol (present for example in geranium and rose, citronella), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salicylic acid, methyl salycilate, terpineol, limonene and mixtures thereof. Preferred actives of essential oils to be used herein are thymol, eugenol, verbenone, eucalyptol, terpineol, cinnamic acid, methyl salicylic acid, limonene, geraniol or mixtures thereof.

Synthetic disinfecting agents or combinations of natural disinfecting agents and synthetic disinfecting agents are also appropriate for use in the present invention. Suitable disinfecting materials are all those known by those skilled in the art for the purpose of disinfecting and may include bleaches like peroxygen bleaches and/or chlorine-type bleaches, antimicrobial essential oils or actives thereof, quaternary ammonium compounds, phenolic compounds, aldehydes like glutaraldehyde, formaldehyde, glyoxal, parabens like ethyl paraben, propyl paraben, methyl paraben, organic acids and peroxy acids, alcohols and mixtures thereof.

Water and Miscellaneous

Water may be present at levels of between about 6% and about 99% by volume. The most preferred amount of water is between about 47% and about 53% by volume. Some of the amides and acids that are present in this composition are known to undergo intermolecular and intramolecular Diels-Alder cyclization reactions. Some of the products of those reactions are known to have biological activity. Because these products are present in the cleaning composition of the current invention, and these products show biological activity, no additional biocide is necessary in this composition at the higher concentrations. At the lower concentrations, a biocide or other type of preservation may be utilized to prevent deterioration. By way of example, but not limitation one of these cyclization products is cyclopinolenic acid. Additionally, small amounts of adjuncts may be added to the composition for aesthetic qualities. These adjuncts include perfumes and dyes.

Enhancing Agents

The cleaning composition may include at least one enhancing agent. By way of example, and not limitation, the at least one enhancing agent can be a skin softening and conditioning agent, a pH control agent, a malodor reducing system, an alcohol, a soil resist, an aromatherapy agent, and combinations thereof.

The invention further provides a method for formulating the cleaning concentrate. The method of formulating the cleaning composition of the present invention relies upon adherence to certain process parameters that lead to a unique product. The order of addition of the various components is critical. It is also vital that the process temperature be maintained throughout the procedure.

The composition is formulated in a reactor. The preferred reactor is a glass or Hastelloy reactor equipped with a reflux condenser and a means of stirring. The means of stirring may be a stir bar or agitator. The reactor should be clean prior to the reaction.

The reactor is charged with a water-soluble organic solvent. A suitable amount of water-soluble organic solvent is between about 3% and about 16% by weight of the total composition. The most preferred amount of water-soluble organic solvent is between about 3% and about 9% by weight of the total composition. In a preferred embodiment the water-soluble organic solvent is a water-soluble organic alcohol. In the most preferred embodiment the water-soluble organic solvent is tetrahydrofurfuryl alcohol (THF-A).

The reactor is charged with an amino alcohol. The stirring mechanism is employed while the reactor is charged with the amino alcohol. The stirring mechanism is continuously employed during the remainder of the process. A suitable amount of amino alcohol is between about 3% and about 9% by weight of the total composition. The amino alcohol undergoes a chemical reaction with the fatty acid in a 1 to 1 mole ratio. However, in the preferred embodiment the fatty acid is present in excess amounts. In a preferred embodiment the amino alcohol is an ethanolamine. In the most preferred embodiment the amino alcohol is monoethanolamine.

The contents of the reactor must be heated. The preferred temperature range for this process is between 75 and 90 degrees Celsius (C.). The most preferred temperature range for this process is between 80 And 85 degrees C. This temperature range is maintained throughout the process. Immediately following additions of various components the batch temperature may fall below this range. At no time should the temperature be allowed to fall below 55 degrees C. The batch temperature should recover quickly to the required range.

At least one fatty acid is added to the reactor. A suitable amount of the at least one fatty acid is between about 7% and about 14% by weight of the total composition. The fatty acid is added via a clean gravity feed vessel. Alternatively a pump type vessel may be employed for the addition. After addition of the fatty acid the contents of the reactor are stirred for a first time period during which the reaction is monitored until it is complete. The reaction may be determined to be complete by any convenient method used in the art. Suitable methods include thin layer chromatography and high performance liquid chromatography.

After the reaction is determined to be complete, a first portion of distilled water is added rapidly. A suitable amount of the first portion of distilled water is between about 1% and about 9% by weight of the total composition. The mixture is stirred for a second time period which is sufficient to allow the composition to form a homogeneous mixture. Preferably the mixture is stirred for at least 10 minutes. The stirring time may increase dramatically corresponding with a scale-up of the process.

The at least one additional surfactant is rapidly added to the reactor. A suitable amount of each additional surfactant is between about 7% and about 30% by weight of the total composition. The most preferred amount of each additional surfactant is between about 8% and about 30% by weight of the total composition. The mixture is stirred for a time period which is sufficient to allow the composition to form a homogeneous mixture. Preferably the mixture is stirred for at least 10 minutes. The stirring time may increase dramatically corresponding with a scale-up of the process.

The chelating agent is added to the reactor. The preferred amount of chelating agent is between about 2% and about 8% by weight of the total composition. The chelating agent may be added to the present composition as an aqueous solution. In a preferred embodiment the chelating agent is added to the composition as an aqueous solution, and the chelating agent is present at a concentration of between about 36% and about 40% by weight in the aqueous solution. A commercially available aqueous solution of a chelating agent, such as Versene, may be used. A suitable amount of the aqueous solution of chelating agent is between about 7% and about 19% by weight of the total composition. The most preferred amount of the aqueous solution of chelating agent is between about 8% and about 19% by weight of the total composition.

Distilled water is added to the reactor and the composition is allowed to cool. A preferred amount of distilled water for the second addition of distilled water is between about 4% and about 44% by weight of the total composition. The composition is allowed to cool to within 25 to 30 degrees C. As the composition is cooling, the disinfecting agent encapsulation element is added to the reactor.

Optionally, after cooling and prior to commercial distribution, the composition may be passed through a filter to remove any debris acquired during the processing steps.

Certain modifications and improvements will occur to those skilled in the art upon a reading of the foregoing description. By way of example, applications for this cleaning composition may be extended to a cleaner for aircrafts which have exterior coatings similar or identical to automobiles. All modifications and improvements have been deleted herein for the sake of conciseness and readability but are properly within the scope of the following claims.

### DESIGN EXAMPLE(S)

This section outlines a design example, not necessarily optimized but illustrative of a suitable method, wherein the cleaning composition of the current invention may be formulated.

### Example

In this preferred embodiment of the method of formulating a cleaning composition in a concentrated form a reactor is charged with tetrahydrofurfuryl alcohol. A stirring mechanism is employed continuously during the remainder of the process. The reactor is then charged with monoethanolamine, wherein the volume of monoethanolamine is one half the volume of the tetrahydrofurfuryl alcohol. The contents of the reactor are heated to within the range of 80 to 90 degrees C. The reactor is charged with tall oil (MeadWestvaco L-5) acquired from MeadWestvaco. The volume of tall oil is equal to the volume of the tetrahydrofurfuryl alcohol. The contents of the reaction are stirred until the reaction is determined to be complete. The reaction progress is followed by thin layer chromatography. The reactor is charged with a first portion of distilled water, wherein the volume of the first portion of distilled water is equal to the volume of the tetrahydrofurfuryl alcohol. The contents of the reaction are stirred for ten minutes. The reactor is charged with the additional surfactants Triton X-100 and Triton X-45, acquired from the Dow Chemical Company, wherein the amount of each additional surfactant is equal to the volume of the tetrahydrofurfuryl alcohol. The contents of the reactor are stirred for ten minutes. The reactor is charged with the commercially available aqueous solution of tetrasodium ethylenediaminetetraacetic acid Versene, wherein the amount of Versene is equal to the volume of the tetrahydrofurfuryl alcohol. The reactor is charged with a second portion of distilled water, wherein the volume of the second portion of distilled water is equal to five times the volume of the tetrahydrofurfuryl alcohol, and the mixture is allowed to cool to about room temperature. As the mixture is cooling, the reactor is charged with the encapsulated disinfectant.

What is claimed is:

1. A cleaning composition comprising:
(a) a water-soluble organic solvent,
(b) at least one amide surfactant,
(c) at least one additional surfactant,
(d) a chelating agent,
(e) at least one disinfecting agent encapsulation element, and
(f) the remainder distilled water.

2. The cleaning composition according to claim 1, wherein the water-soluble organic solvent is a water-soluble organic alcohol and is between about 3% and about 16% by weight of the total composition.

3. The cleaning composition according to claim 1, wherein the at least one amide surfactant is the product of the saponification of at least one fatty acid by an amino alcohol.

4. The cleaning composition according to claim 3, wherein the amount of amino alcohol is between about 3% and about 9% by weight of the total composition.

5. The cleaning composition according to claim 3, wherein the at least one fatty acid may contain rosin acids present in small amounts not to exceed about 5% by weight of the total weight of the at least one fatty acid.

6. The cleaning composition according to claim 3, wherein the at least one fatty acid is chosen from the group comprising saturated fatty acids of the general formula CₓH₂ₓO₂, wherein the value of x is any whole number between and including 16 and 24; monounsaturated or polyunsaturated fatty acids of the general formula CₓH_{(2x-y)}O₂, wherein the value of x is any whole number between and including 16 and 20 and y is either 2 or 4; and mixtures thereof.

7. The cleaning composition according to claim 6, wherein the at least one fatty acid may contain rosin acids present in small amounts not to exceed about 5% by weight of the total weight of the at least one fatty acid.

8. The cleaning composition according to claim 3, wherein the at least one fatty acid is chosen from the group comprising palmitic acid; palmitoleic acid; stearic acid; oleic acid; linoleic acid; 5,9,12-octadecatrienoic acid; 5,11,14-eicosatrienoic acid; cis,cis-5,9-octadecadienoic acid; cis-11-octadecanoic; eicosanoic acid; docosanoic acid; tetracosanoic acid; and mixtures thereof.

9. The cleaning composition according to claim 1, wherein the at least one amide surfactant is at least one fatty acid amide.

10. The cleaning composition according to claim 9, wherein the at least one fatty acid amide is a member of the group of amides comprising compounds with the structure CH₃(CH₂)ₓCONH(CH₂)₂OH, wherein the value of x is any whole number between and including 14 and 22; CH₃(CH₂)ₓCH═CH(CH₂)_{y}CONH(CH₂)₂OH, wherein the value of x+y is any whole number between and including 12 and 16; CH₃(CH₂)ₓCH═CH(CH₂)_{y}CH═CH(CH₂)_{z}CONH(CH₂)₂OH, wherein the value of x+y is any whole number between and including 10 and 14; and mixtures thereof.

11. The cleaning composition according to claim 1, wherein the amount of the at least one additional surfactant is between about 7% and about 30% by weight of the total composition.

12. The cleaning composition according to claim 1, wherein the amount of the chelating agent is between about 2% and about 8% by weight of the total composition.

13. The cleaning composition according to claim 1, wherein the at least one disinfecting agent encapsulation element comprises at least one disinfecting agent and an encapsulating material.

14. The cleaning composition according to claim 13, wherein the encapsulating material is selected from the group consisting of polysiloxanes, natural waxes, natural gums, synthetic waxes, synthetic gums, fatty acids, fatty esters, fatty alcohols, fatty amines, fatty amides, alkyl phenols, polyethylene wax, polyalkylenes and derivatives thereof, and combinations thereof.

15. The cleaning composition according to claim 13, further comprising a carrier material.

16. The cleaning composition according to claim 13, further comprising a binder.

17. The cleaning composition according to claim 13, wherein the at least one disinfecting agent is released from the cleaned surface by slow diffusion through the encapsulating material.

18. A cleaning composition comprising:
(a) a water-soluble organic solvent;
(b) at least one amide surfactant, wherein the at least one amide surfactant is the product of the saponification of at least one fatty acid by an amino alcohol;
(c) at least one additional surfactant, wherein the at least one additional surfactant is a polyethylene oxide condensate of an alkylphenol;
(d) a chelating agent, wherein the chelating agent is an aminocarboxylic acid salt;
(e) at least one disinfecting agent encapsulation element, and
(f) the remainder distilled water,
wherein the at least one disinfecting agent is released from the cleaned surface by slow diffusion through the encapsulating material.

19. The cleaning composition according to claim 18, wherein the at least one disinfecting agent encapsulation element comprises at least one disinfecting agent and an encapsulating material.

20. The cleaning composition according to claim 18, wherein the encapsulating material is selected from the group consisting of polysiloxanes, natural waxes, natural gums, synthetic waxes, synthetic gums, fatty acids, fatty esters, fatty alcohols, fatty amines, fatty amides, alkyl phenols, polyethylene wax, polyalkylenes and derivatives thereof, and combinations thereof.
